(19) United States
(12) Patent Application Publication
(10) Pub. No.: US 2024/0422867 A1
(43) Pub. Date: Dec. 19, 2024

(54) DOMESTIC APPLIANCE DEVICE

(71) Applicant: BSH Hausgeräte GmbH, Munich (DE)

(72) Inventors: Javier Lasobras Bernad, EJEA DE LOS CABALLEROS (ZARAGOZA) (ES); Damaso Martin Gomez, Zaragoza (ES); Julio Rivera Peman, Cuarte de Huerva (Zaragoza) (ES); Jesús Ricardo Ruiz Gracia, Movera (Zaragoza) (ES)

(21) Appl. No.: 18/684,710

(22) PCT Filed: Sep. 7, 2022
(86) PCT No.: PCT/EP2022/074805

§ 371 Date: Feb. 19, 2024

(30) Foreign Application Priority Data
Sep. 24, 2021 (EP) 21382856.9

(51) Int. Cl. H05B 6/12

(52) U.S. Cl. CPC H05B 6/1218

(57) ABSTRACT

A household appliance apparatus, in particular a cooktop apparatus, includes a light source and a light guiding unit designed to guide light from the light source to a target region. The light guiding unit includes a tubular structure designed to surround a hollow channel for guiding light and including a reflective inner surface.

The invention relates to a household appliance apparatus as claimed in claim 1 and a method for producing this household appliance apparatus as claimed in claim 14.

Cooktops which have light guiding units are known from the prior art. These conventional light guiding units are formed as solid bodies of transparent material, in which the light is guided and prevented from exiting from the material by total reflection.

The object of the invention, in particular but not limited thereto, is to provide a generic apparatus with improved properties regarding a cost saving and/or a longer lifetime. The object is achieved according to the invention by the features of claim 1, while advantageous embodiments and developments of the invention can be derived from the dependent claims.

The invention is based on a household appliance apparatus, in particular a cooking appliance apparatus, advantageously a cooktop apparatus, particularly advantageously an induction cooktop apparatus, comprising at least one light source and at least one light guiding unit for guiding light from the light source to a target region.

It is proposed that the light guiding unit has a tubular structure which surrounds a hollow, in particular air-filled, channel for guiding light and which has a reflective inner surface.

By means of such an embodiment, in particular, a reduced aging effect is achieved relative to conventional light guides made of plastic, in particular an attenuation of the quantity of transported light due to yellowing. For example, a color reproduction by means of a hollow light guide is not impaired, or is impaired to a lesser extent, by age-related yellowing of the materials. Moreover, it is possible to achieve a cost saving and/or simple production relative to a use of conventional light guides made of glass, which generally have complex manufacturing methods.

A “household appliance apparatus”, in particular a “cooking appliance apparatus”, advantageously a “cooktop apparatus”, and particularly advantageously an “induction cooktop apparatus” is intended to be understood to mean, in particular, at least one part, in particular a subassembly, of a household appliance, in particular a cooking appliance, advantageously a cooktop, and particularly advantageously an induction cooktop. For example, a household appliance comprising the household appliance apparatus could be a chest freezer and advantageously a refrigerator and/or upright freezer. A household appliance comprising the household appliance apparatus could alternatively or additionally be a dishwasher and/or a washing machine and/or a dryer, for example. Advantageously, a household appliance comprising the household appliance apparatus is a cooking appliance. A household appliance configured as a cooking appliance could be an oven and/or a microwave and/or a grill appliance and/or steam cooking appliance, for example. Advantageously, a household appliance configured as a cooking appliance is a cooktop and preferably an induction cooktop.

“Provided” is intended to be understood to mean, in particular, specifically designed and/or equipped. An object being provided for a specific function is intended to be understood to mean, in particular, that the object fulfills and/or executes this specific function in at least one use state and/or operating state.

The light source is provided, for example, to emit electromagnetic waves in the visible spectral range. The light source can emit monochromatic light. Alternatively, the light source can emit a mixture of light of different wavelengths. For example, the light source can emit light which corresponds to a specific color when observed, in particular, by a typical person. Alternatively, the light source can be provided to emit white light. For example, the light source has a filter which limits a frequency range of emitted light or the light source is provided to generate only light of specific wavelengths or wavelength ranges. For example, the light source is configured as an incandescent lamp or gas discharge lamp, but preferably as a semi-conductor light source, in particular LED or OLED. Alternative light sources are also possible. In particular, the light source differs from a laser light source. For example, in different operating states the light source is suitable for emitting light of different spectral composition, in particular of a different color.

The target region, for example, is a region which is intended to be illuminated for displaying information and/or for aesthetic purposes. The target region is advantageously arranged, in particular positioned, such that in a regular operating state this target region is visible, in particular can be viewed, by a user of a household appliance comprising the household appliance apparatus.

Advantageously, the tubular structure surrounds the channel over the periphery relative to a light transport direction, in particular from the light source to the target region, in particular by at least 90%, advantageously by at least 98%, preferably entirely. In particular, the tubular structure forms a channel, the cross section thereof having at least in some portions a polygonal, rectangular, square, circular or oval shape, in particular relative to the light transport direction. A shape of the cross section of the channel can be configured differently in some portions. Advantageously, a shape of the cross section of the channel is at least substantially equal over at least a large part of an extent of the channel. In particular, a cross-sectional surface of the channel, in particular relative to the light transport direction, is less than 100 mm², in particular less than 50 mm², for example less than 20 mm². In particular, a cross-sectional surface of the channel, in particular relative to the light transport direction, is greater than 1 mm², in particular greater than 10 mm², for example greater than 20 mm². Light originating from the light source advantageously enters the tubular structure through an inlet opening at the light source and exits from the tubular structure through an outlet opening, advantageously at the target region, in particular directly at the target region and/or directed toward the target region.

The tubular structure can be formed, for example, from metal, from plastic, from ceramic, from glass and/or a combination of these materials. The tubular structure can be formed in some portions from different materials in the light transport direction and/or over the periphery. In particular, the tubular structure is formed from a non-transparent material.

The “inner surface” of the tubular structure is intended to be understood to mean a total number of all surfaces of the tubular structure which face the channel and/or which define this channel directly over the periphery.

In particular, at least a large part, in particular at least 80%, advantageously at least 95%, particularly advantageously at least 99%, preferably 100%, of the reflective inner surface has a reflectivity of at least 80%, in particular at least 90%, advantageously at least 95%, preferably of at least 99%. In particular, the reflective inner surface has a proportion of at least 50%, in particular at least 80%, advantageously at least 90%, preferably at least 95% of directed reflection.

The reflective inner surface can be formed directly from the material of the tubular structure. Alternatively, it is possible that the reflective inner surface is at least partially, advantageously entirely, formed from a coating which is applied to the material of the tubular structure. The coating can be single-layered or multi-layered and can be formed from a single coating material or a plurality of coating materials.

Alternatively, the reflective inner surface has been formed by a mechanical and/or chemical polishing and/or planarization during the production of the household appliance apparatus and/or the tubular structure. The reflective inner surface can also be already formed intrinsically by the production process of the tubular structure per se. For example, molds for an injection molding process or a forming process, such as for example a thermo-forming process, a compression molding process, in particular deep-drawing, or a vacuum forming process, or a nozzle for an extrusion process, have highly polished surfaces which are transferred to the molded part, i.e. in particular the tubular structure or parts of the tubular structure, in order to form the reflective surface.

According to a further embodiment, a large part of the light guiding unit, in particular at least 50%, advantageously at least 90%, preferably at least 95%, is formed by the tubular structure. As a result, in particular, a simple construction and/or a cost saving can be achieved. In particular, an effective light guidance, in particular regarding low losses, can be achieved.

Alternatively, the light guiding unit can have at least one portion, in particular relative to a light transport direction which is formed by the tubular structure, while at least a further portion of the light guiding unit is formed by a conventional light guide.

It is further proposed that the tubular structure extends from the light source to the target region. In particular, a distance from the light source to a start of the tubular structure is less than 10 mm, advantageously less than 5 mm, preferably less than 1 mm. In particular, a distance from one end of the tubular structure to the target region is less than 30 mm, advantageously less than 15 mm, preferably less than 3 mm. In particular, low losses can be achieved relative to the light transport.

It is further proposed that at least one target region-side end of the light guiding unit is guided in a hot region. In at least one regular operating state, temperatures above 100° C., in particular above 200° C., for example above 250° C., are present in a hot region. In particular, the household appliance apparatus has at least one heating element which directly or indirectly heats up the hot region. In such a case the advantages of the invention are particularly relevant, since conventional light guides made of plastic are subjected in hot regions to a rapid aging which influences a light quality, in particular regarding yellowing.

According to a further embodiment, it is proposed that the household appliance apparatus has at least one household appliance plate, wherein the target region is located on the household appliance plate and the light is provided to shine through the household appliance plate. In particular, the household appliance plate forms a household appliance outer face, in particular a household appliance front, which can be touched by a user in a regular operating state. For example, the household appliance plate is configured as a cooktop plate. Alternatively, the household appliance plate is configured as a household appliance door, for example for closing a cooking or refrigerating space. The household appliance plate is at least partially transparent at least in the target region, and thus has a transparency of at least 50%, advantageously at least 80%, preferably at least 95%.

A maximum extent, in particular a longitudinal extent, of the tubular structure corresponds, for example, at least to 20%, in particular at least to a third, for example at least to 60% of a maximum extent of the household appliance plate.

The light source is arranged, for example, in an edge region of the household appliance plate. The light source is intended to be considered as arranged, for example, in the edge region of the household appliance plate when a perpendicular projection of the light source onto the household appliance plate, in particular perpendicularly relative to a main extension plane of the household appliance plate, is located in an edge region of the household appliance plate, in particular is removed by a maximum of 10% of a maximum extent of the household appliance plate from an edge of the household appliance plate. In particular, the light guiding unit extends, in particular in a perpendicular projection, from an edge region of the household appliance plate into a central region of the household appliance plate. In particular, the light guiding unit extends, in particular in a perpendicular projection, from a first edge region of the household appliance plate into a second edge region of the household appliance plate which at least substantially opposes the first edge region.

It is further proposed that at least a large part of the tubular structure is arranged at least substantially parallel to the household appliance plate, in particular at least substantially parallel to a main plane of the household appliance plate.

Moreover, the household appliance apparatus can have a partition plate which is provided to separate at least one heating element region from an electronics region, wherein the tubular structure is formed at least partially from the partition plate. In particular, at least one heating element, such as for example an induction heating element, alternatively a radiation heating element or a resistance heating element, is arranged in the heating element region. For example, the partition plate is arranged at least substantially parallel to the household appliance plate. In particular, the hot region extends in the heating element region. In particular, the heating element region is arranged between the partition plate and the household appliance plate. In particular, the light guiding unit is arranged at least partially on a side of the partition plate facing away from the household appliance plate. For example, a control electronics and/or a supply electronics, in particular at least one power electronics, in particular for the heating elements in the heating element region, are arranged and/or accommodated in the electronics region.

According to a further embodiment, it is proposed that at least a partial portion of the tubular structure is formed from at least two partial elements which in each case partially define the hollow channel over the periphery. For example, the elements are connected together by a positive connection, a material connection and/or non-positive connection. In particular, the tubular structure is formed from, in particular, an upper partial element facing the household appliance plate and, in particular, a lower partial element facing away from the household appliance plate. For example, the partial element facing the household appliance plate is formed by the partition plate. As a result, in particular, it is possible to achieve a simple manufacture and/or high degree of reflectivity since the surfaces of the partial elements forming the reflective inner surface are thus the outer surfaces and thus are more easily accessible, in order to increase a reflectivity of the partial elements by means of further method steps, in particular by means of polishing and/or coating. Advantageously, the elements are formed from different materials, in particular regarding a temperature stability.

Alternatively or additionally, it is proposed that at least one partial portion of the tubular structure is configured in one piece over the periphery.

It is further proposed that the household appliance apparatus has at least one, in particular at least three, advantageously at least 8, preferably at least 15, further light source(s) and at least one, in particular at least three, advantageously at least 8, preferably at least 15 further light guiding unit(s) for guiding light in each case from the further light source(s) to one respective further target region, wherein the further light guiding unit(s) in each case has/have at least one further tubular structure which in each case surrounds a further hollow channel for guiding light and which has in each case a further reflective inner surface, wherein the tubular structure and the further tubular structure have at least one common component. For example, the tubular structure and the further tubular structure are arranged at least substantially in parallel.

A household appliance having a household appliance apparatus as described above, and a method for producing a household appliance apparatus as described above are also proposed.

The household appliance apparatus is not intended to be limited herein to the above-described use and embodiment. In particular, the household appliance apparatus can have a number of elements, components and units deviating from a number mentioned herein for fulfilling a mode of operation described herein.

Further advantages are found in the following description of the drawing. Exemplary embodiments of the invention are shown in the drawing. The drawing, the description and the claims contain numerous features in combination. A person skilled in the art will also expediently consider the features individually and combine them to form further meaningful combinations.

In the drawing:

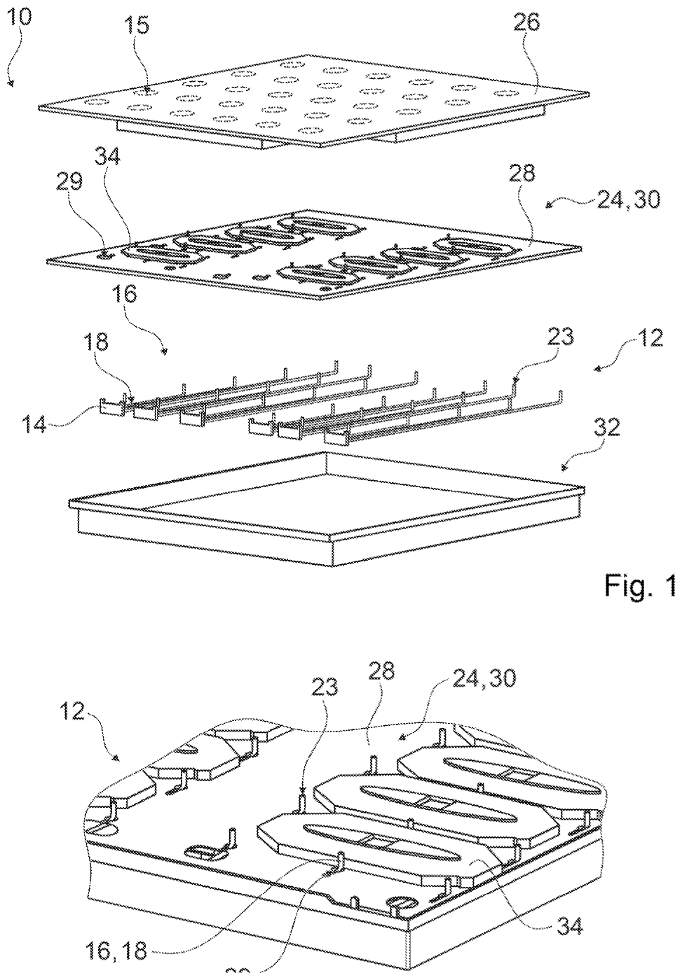

FIG. 1 shows an exploded view of a household appliance, configured as a cooktop, comprising a household appliance apparatus,

FIG. 2 shows a detailed view of the household appliance apparatus of FIG. 1 without the household appliance plate,

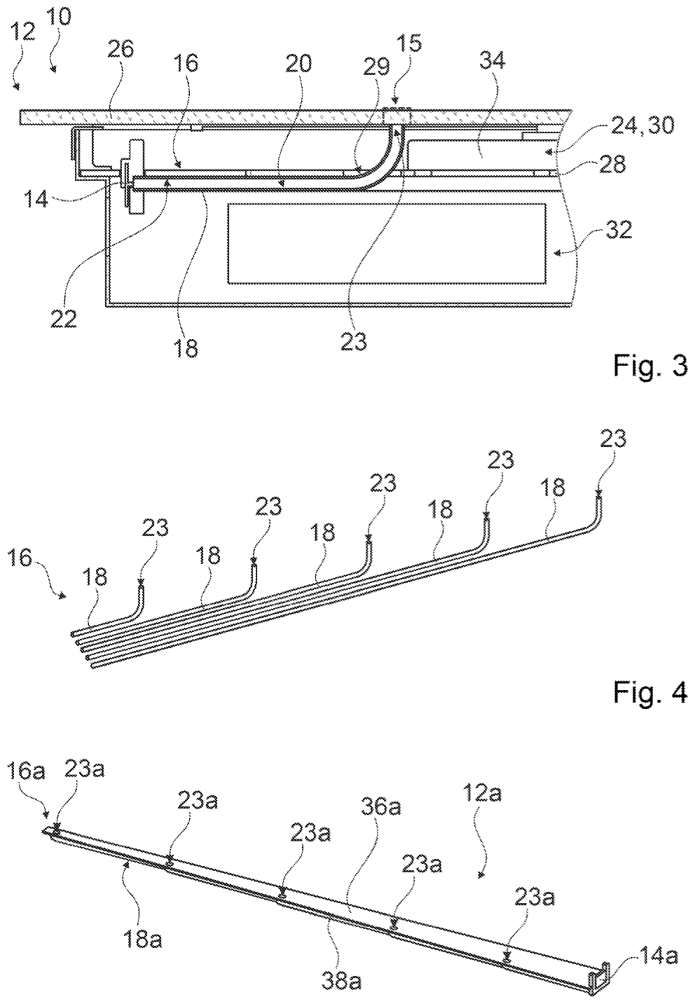

FIG. 3 shows a sectional view of the household appliance of FIG. 1 along a light transport direction through a tubular structure,

FIG. 4 shows tubular structures of the household appliance apparatus of FIGS. 1-3,

FIG. 5 shows a second exemplary embodiment of a household appliance apparatus,

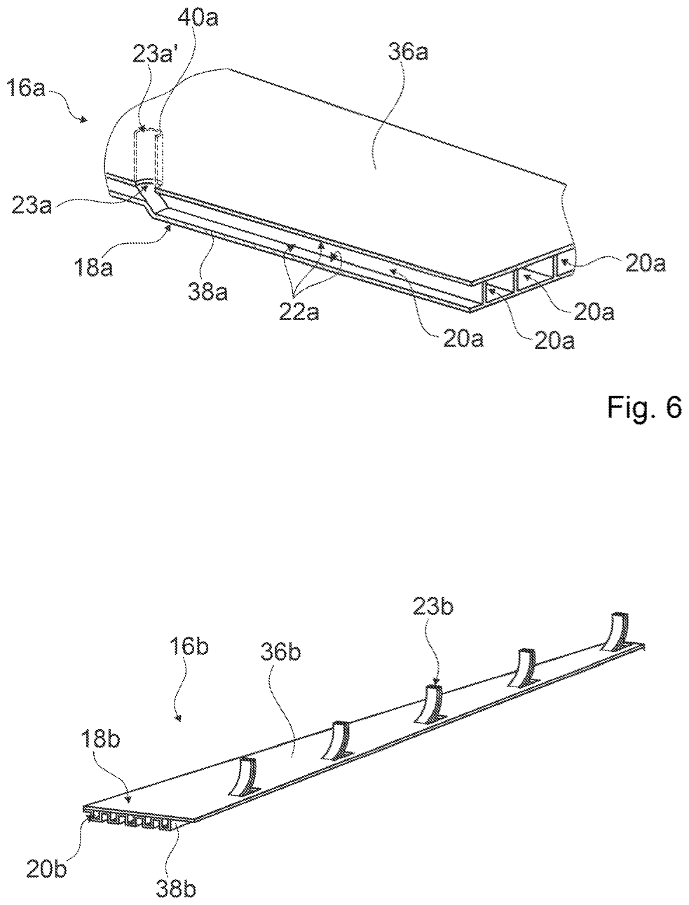

FIG. 6 shows a detailed view of the household appliance apparatus of FIG. 5 in a sectional view along a light transport direction through a tubular structure,

FIG. 7 shows a tubular structure of a third exemplary embodiment,

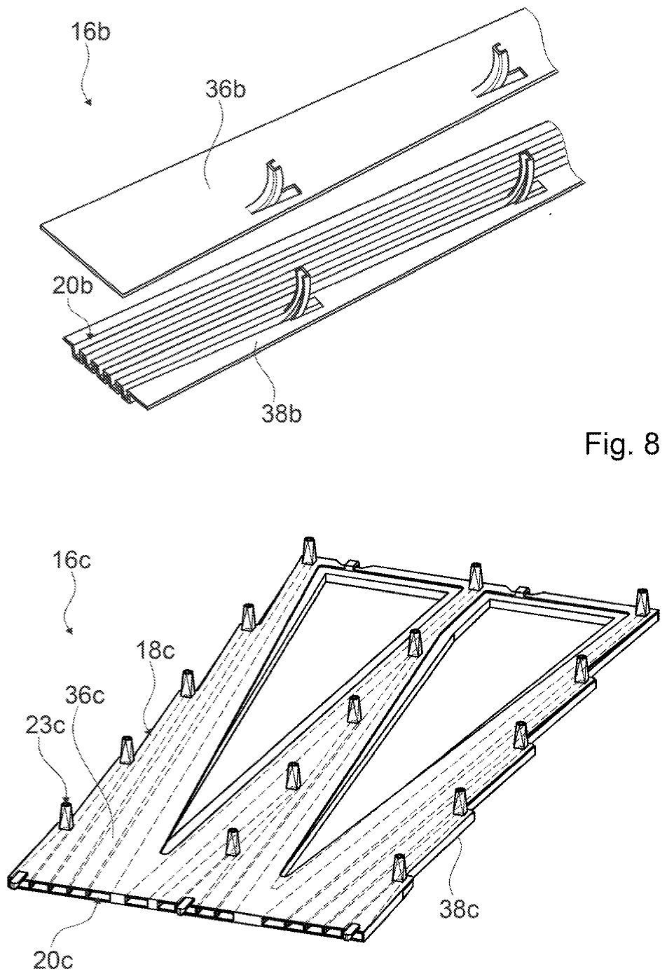

FIG. 8 shows an exploded view of the tubular structure of FIG. 7 and

FIG. 9 shows a fourth exemplary embodiment of a tubular structure.

For reasons of clarity, at least in the more complex figures, of the objects repeatedly present, in particular even if they have different extents/sizes, in each case only one is provided with a reference sign.

FIGS. 1 to 4 show a household appliance 10 comprising a household appliance apparatus 12 in various views. The household appliance 10 is configured as a cooktop and the household appliance apparatus 12 is configured as a cooktop apparatus. The household appliance 10 is configured as an induction cooktop and the household appliance apparatus 12 is configured as an induction cooktop apparatus.

The household appliance apparatus 12 has 30 light sources 14. The light sources 14 are configured as LED light sources.

The household appliance apparatus 12 has one respective light guiding unit 16 for each of the light sources 14 for guiding light from the light source 14 to a target region 15. The light guiding units 16 have in each case a tubular structure 18 which surrounds a hollow channel 20 for guiding light and which has a reflective inner surface 22.

A large part of the light guiding unit 16 is formed by the tubular structure 18. The light guiding unit 16 is formed entirely by the tubular structure 18.

The tubular structure 18 extends from the respective light source 14 to the respective target region 15.

The household appliance apparatus 12 also has a household appliance plate 26. The household appliance plate 26 is configured as a cooktop plate. The target regions 15 in each case are located on the household appliance plate 26 and the light is provided to shine through the household appliance plate 26. The household appliance plate 26 is arranged in a regular operating state such that a usable surface (cooking surface) is oriented horizontally. The light is provided to shine from below, i.e. in particular from behind the household appliance plate 26 through the household appliance plate 26. The illumination of the target regions 15 serves to show a user the limits (edges/corners) of hot regions on the household appliance plate 26. The target regions 15 are in each case configured as dots, in particular as punctiform marks. A size, in particular an order of magnitude of the size, of the target regions 15 corresponds, in particular at least substantially to a size, in particular an order of magnitude of the size, of the cross-sectional surface of the respective hollow channel 20. In further embodiments, it can be provided that a color of the light source 14 is adapted to a temperature or a heating power in the vicinity of the target region 15. In further embodiments, it can be provided that the color of the light sources 14 is adapted using an assignment to a cooking region (cooking zone)—light sources 14 whose light is guided to target regions 15 of the same cooking zone can have the same color, while light sources 14 whose light is guided to target regions 15 in different cooking zones have different colors. The household appliance plate 26 is formed from glass ceramic. The household appliance plate 26 has a coating outside the target regions 15 in order to reduce a transparency of the household appliance plate 26 outside the target regions 15. The target regions 15 form a regular grid (five rows by six columns) on the household appliance plate 26.

The light sources 14 are arranged in an edge region of the household appliance plate 26. The household appliance plate 26 is rectangular-shaped and the light sources 14 are arranged along one side, in particular a front side, of the household appliance plate 26. According to the position of the target region 15, a maximum extent of the tubular structures 18 accordingly corresponds to between 10% and 90% of a size of the extent of the household appliance plate 26 perpendicular to the side on which the light sources 14 are arranged.

The household appliance apparatus 12 also has a partition plate 28 which is provided to separate a heating element region 30 from an electronics region 32.

The household appliance apparatus 12 has heating elements 34 which are arranged in the heating element region 30. The heating elements 34 are configured as induction heating elements (inductors). Control and power electronics of the household appliance apparatus 12 are arranged in the electronics region 32. The partition plate 28 is formed from aluminum. The partition plate 28 reduces an influence of the heating elements 34 on the control and power electronics. The partition plate 28 thermally shields the electronics region 32 from the heating element region 30.

The heating element region 30 forms a hot region 24. The hot region 24 is heated up mainly by thermal discharge, in particular by thermal conduction and/or thermal radiation, from an item of cookware heated up by the heating elements 34 through the household appliance plate 26. At least one target region-side end of the light guiding unit 16 is guided in the hot region 24. The target region-side end of the light guiding units 16 are guided in each case through a hole 29 in the partition plate 28. The light guiding units 16 have in each case an outlet opening 23 on the target region-side end. The target region-side end bears against the household appliance plate 26 and/or is at a distance of less than 1 mm therefrom. The outlet opening 23 is located directly on the target region 15.

Light is transported along the channels 20 substantially parallel to the household appliance plate 26. A large part of the tubular structure 18 is arranged at least substantially parallel to the household appliance plate 26. A large part of the tubular structure 18 is arranged on a side of the partition plate 28 facing away from the household appliance plate 26.

The tubular structure 18 is configured in one piece over the periphery. The tubular structure 18 is formed from a tube. The tube is a round tube. The tube has a diameter of approximately 4 mm. The tubular structure 18 is formed from aluminum. The tubular structure 18 has been bent on the target region-side end in order to change a light transport direction—from parallel to the household appliance plate 26 to perpendicular to the household appliance plate 26. The tubular structure 18 has on the target region-side end a curvature with a radius of curvature of between 0.5 cm and 5 cm, for example approximately 2 cm.

The tubular structure 18 has been polished mechanically during production, for example. Alternatively, it is possible that the tubular structure 18 already has intrinsically a high level of reflectivity due to its production.

The tubular structures 18 which lead to different target regions 15, i.e. in particular at least to target regions 15 which are arranged in a common “column” of the grid, are arranged parallel to one another (see FIG. 4).

Further exemplary embodiments of the invention are shown in FIGS. 5 to 9. The following descriptions are substantially limited to the differences between the embodiments, wherein relative to components, features and functions remaining the same, reference can be made to the description of the exemplary embodiment of FIGS. 1 to 4. For differentiating between the exemplary embodiments, the reference signs of the exemplary embodiments according to FIGS. 5-9 are supplemented by the letters a, b and c. Relative to components remaining the same, in particular relative to components with the same reference signs, in principle reference can also be made to the drawings and/or the description of the exemplary embodiment of FIGS. 1 to 4. In particular in the context of the description, it is assumed that the light guiding units 16a, 16b, 16c of FIGS. 5 to 9 are installed in a household appliance 10 according to FIGS. 1 to 4 instead of the light guiding units 16 provided therein. This does not exclude that the proposed light guiding units 16, 16a, 16b, 16c are used in different types of household appliances.

FIGS. 5 and 6 show a household appliance apparatus 12a. The household appliance apparatus 12a has a plurality of light guiding units 16a. The light guiding units 16a have in each case a tubular structure 18a. The tubular structures 18a in each case enclose a hollow channel 20a.

The tubular structures 18a are formed in a first portion of the light guiding unit 16a from two partial elements 36a, 38a over the periphery. The partial elements 36a, 38a in each case partially define the hollow channels 20a over the periphery. The first portion is guided in an electronics region 32. An upper partial element 36a is configured to be plate-shaped, i.e. in particular flat. A lower partial element 38a has a U-shaped profile, i.e. in particular in cross section. The upper partial element 36a is provided to close the opening of the U-shaped profile, in order to form the tubular structure 18a. The tubular structures 18a in each case have a rectangular cross section.

The lower partial element 38a has a plurality of U-shaped profiles located adjacent to one another in order to form together with the upper partial element 36a a plurality of tubular structures 18a. Walls of the lower partial element 38a, which are located between two of the tubular structures 18a, form part of both tubular structures 18a. On a target region-side end of the tubular structure 18a, the lower partial element 38a has in each case a ramp or an angled path, in order to direct upwardly the light which is initially transported in the channel 20a parallel to the household appliance plate 26, i.e. in particular perpendicular to the household appliance plate 26. The upper partial element 36a also has an opening in the region of the ramp in order to allow light through in the direction of the target region 15. The opening forms an outlet opening 23a of the tubular structure 18a. The tubular structures 18a are arranged such that in each case the openings are located in the region of a hole 29 through the partition plate 28. The outlet openings 23a are arranged removed from the household appliance plate 26, for example, by approximately 1 cm to 2 cm. A distance of the outlet opening 23a from the household appliance plate 26 corresponds at least substantially to a distance of the household appliance plate 26 from the partition plate 28.

The household appliance apparatus 12a has one light source 14a for each of the five light guiding units 16a shown. The five light guiding units 16a are provided in each case to guide light from the respective light source 14a to one respective target region 15. The light guiding units 16a have in each case a tubular structure 18a, which in each case surround a hollow channel 20a for guiding light and which in each case have a reflective inner surface 22a, and the tubular structures 18a have at least one (two) common component(s), i.e. in particular the partial elements 36a, 38a.

The upper and lower partial element 36a, 38a are a constituent part of a plurality of the tubular structures 18a. At least the tubular structures 18a which lead to the target regions 15, which are located one behind the other when viewed from one side of the household appliance 10 on which the light sources 14a are arranged, in particular at least those which are located in a common column of a grid of the target regions 15, are formed from the same upper and lower partial elements 36a, 38a.

The partial elements 36a, 38a are in each case formed by a temperature-stable plastic, for example PBT (polybutylene terephthalate), LCP (liquid crystal polymer) and/or PET (polyethylene terephthalate). Molds for producing the partial elements 36a, 38a, for example by means of injection molding, have highly polished surfaces so that they form a reflective inner surface 22a on the partial elements 36a, 38a. Alternatively or additionally, at least surfaces of the partial elements 36a, 38a can be provided with a coating, in particular a white paint or a white lacquer, in order to form the reflective inner surfaces 22a of the tubular structures 18a.

The partial elements 36a, 38a are connected to one another by a material connection by means of adhesive, for example epoxy adhesive. Alternatively, non-positive or positive connections are also possible.

According to an alternative, it is proposed that the upper partial element 36a of the tubular structure 18a is formed partially or entirely from the partition plate 28.

The first portion is arranged entirely outside a hot region 24—in particular in an electronics region 32.

According to one embodiment, the first portion is the sole portion of the tubular structure 18a, so that light is freely transported from the outlet opening 23a, i.e. in particular without channeling, to the target region 15.

According to a further embodiment, the light guiding unit 16a in each case has a second portion which is guided in the hot region 24. The second portion is formed in each case from a third partial element 40a (shown in dashed lines in FIG. 6, since it is optional). The third partial element 40a is a part of the tubular structure 18a. The third partial element 40a in each case conducts (guides) light from the end of the first portion, in particular the opening therein, to the respective target region 15, in particular through one respective hole 29 in a partition plate 28. A target region-side end of the third partial element 40a forms an outlet opening 23a′ through which the light exits and falls onto the target region 15. The second portion of the tubular structure 18a is configured, for example, hollow cylindrically, in particular as a tube. The second portion can be formed from a material with a higher temperature stability than the first portion. The second portion can be manufactured from metal, or alternatively from plastic. The second portions are formed in each case over the periphery from a single element, in particular the third partial element 40a.

According to a further embodiment, it is proposed that the first portion of the light guiding unit 16a is formed from a conventional light guide, while only the second portion guided in a hot region 24 has a tubular structure 18a.

FIGS. 7 and 8 show a further embodiment of light guiding units 16b. Five light guiding units 16b (in further embodiments other numbers, in particular between 1 and 50 are conceivable) are in each case formed from a common upper partial element 36b and a common lower partial element 38b. The upper partial element 36b is configured to be substantially plate-shaped, i.e. in particular flat in one plane. The upper partial element 36b has tongue-like configurations which emerge from the plane following a rounding, only at the points which form outlet openings 23b. The lower partial element 38b has a wave-shaped cross section, in particular a rectangular wave shape, wherein in each case a wave trough forms a tubular structure 18b of one respective light guiding unit 16b by being covered by the upper partial element 36b. On the target region-side ends of the respective light guiding unit 16b the lower partial element 38b has in each case a shaped portion which protrudes through a hole in the upper partial element 36b. The shaped portion of the lower partial element 38b and the tongue-like configuration of the upper partial element 36b in each case follow the same rounding and are joined together, in order to continue the respective tubular structure 18b. The tongue-like configuration and the shaped portion are provided in each case to protrude through a hole 29 of a partition plate 28.

FIG. 9 shows a further embodiment of light guiding units 16c. 15 light guiding units 16c are formed here by two common partial elements 36c, 38c. The partial elements 36c, 38c enclose 15 tubular structures 18c which in each case surround a channel 20c for the light guide.

The fifteen light guiding units 16c in this case guide light to fifteen target regions 15. The target regions 15 correspond to three columns of a grid formed by the target regions, with in each case five target regions 15. A household appliance according to FIG. 1 would have two of the components shown in FIG. 9 in order to reach all of the target regions 15. The channels 20c, which belong to a right-hand column of the three columns of target regions 15, run substantially in parallel. The channels 20c, which belong to a left-hand column of the three columns of target regions 15, run substantially in parallel. The channels 20c which belong to a central column of the three columns of target regions 15 run in different directions in order to achieve a smaller size. Alternatively, the channels of the central column could also run in parallel.

The upper partial element 36c has in each case a dome-like shaped portion on the target region-side ends of the tubular structures 18c. The dome-like shaped portions are provided to protrude through holes 29 in a partition plate 28 as far as a household appliance plate 26.

Alternatively, it is conceivable that the light guiding units 16c are formed from a common single element which is produced, for example, by an additive process, for example 3D printing.

Although only embodiments of the tubular structure which consist of two parts which are separated in the horizontal plane, i.e. into “top” and “bottom”, are shown here, further embodiments are possible in which the tubular structures are divided in the longitudinal direction in the vertical plane, i.e. for example into “right” and “left”.

### REFERENCE SIGNS

10 Household appliance
12 Household appliance apparatus
14 Light source
15 Target region
16 Light guiding unit
18 Tubular structure
20 Channel
22 Inner surface
23 Outlet opening
24 Hot region
26 Household appliance plate
28 Partition plate
29 Hole
30 Heating element region
32 Electronics region
34 Heating element
36 Partial element
38 Partial element
40 Partial element

1-14. (canceled)

15. A household appliance apparatus, in particular a cooktop apparatus, comprising:
a light source; and
a light guiding unit designed to guide light from the light source to a target region, said light guiding unit comprising a tubular structure designed to surround a hollow channel for guiding light and comprising a reflective inner surface.

16. The household appliance apparatus of claim 15, wherein the light guiding unit includes a large part which is formed by the tubular structure.

17. The household appliance apparatus of claim 15, wherein the tubular structure extends from the light source to the target region.

18. The household appliance apparatus of claim 15, wherein the light guiding unit comprises a target region-side end which is guided in a hot region.

19. The household appliance apparatus of claim 15, further comprising a household appliance plate designed to enable light to shine through, said target region being located on the household appliance plate.

20. The household appliance apparatus of claim 15, wherein the household appliance plate is a cooktop plate.

21. The household appliance apparatus of claim 19, wherein the tubular structure has a maximum extent which corresponds at least to a third of a maximum extent of the household appliance plate.

22. The household appliance apparatus of claim 19, wherein the light source is arranged in an edge region of the household appliance plate.

23. The household appliance apparatus of claim 19, wherein at least a large part of the tubular structure is arranged at least substantially parallel to the household appliance plate.

24. The household appliance apparatus of claim 15, further comprising a partition plate designed to separate a heating element region from an electronics region, said tubular structure being formed at least partially from the partition plate.

25. The household appliance apparatus of claim 15, wherein the tubular structure includes at least a partial portion which is formed from at least two partial elements, each of the at least two partial elements partially defining the hollow channel over a periphery.

26. The household appliance apparatus of claim 15, wherein the tubular structure includes at least one partial portion which is designed in one piece over a periphery.

27. The household appliance apparatus of claim 15, further comprising:
a further light source; and
a further light guiding unit designed to guide light from the further light source to a further target region, said further light guiding unit comprising a further tubular structure designed to surround a further hollow channel for guiding light and including a further reflective inner surface,
wherein the tubular structure and the further tubular structure comprise at least one common component.

28. A household appliance, in particular a cooktop, comprising a household appliance apparatus, said household appliance apparatus comprising a light source, and a light guiding unit designed to guide light from the light source to a target region, said light guiding unit comprising a tubular structure designed to surround a hollow channel for guiding light and comprising a reflective inner surface.

29. A method for producing a household appliance apparatus, the method comprising:
designing a light guiding unit with a tubular structure that defines a hollow channel to guide light from a light source to a target region; and
designing the tubular structure in surrounding relation to the hollow channel with a reflective inner surface.

30. The method of claim 29, wherein the tubular structure is designed to extend from the light source to the target region.

31. The method of claim 29, further comprising:
designing a household appliance plate to enable light to shine through; and
arranging the target region on the household appliance plate.

32. The method of claim 31, wherein the tubular structure is designed to have a maximum extent which corresponds at least to a third of a maximum extent of the household appliance plate.

33. The method of claim 31, further comprising arranging the light source in an edge region of the household appliance plate.

34. The method of claim 29, further comprising:
separating a heating element region from an electronics region by a partition plate; and
forming the tubular structure at least partially from the partition plate.
